(19) United States
(12) Patent Application Publication
(10) Pub. No.: US 2026/0099915 A1
(43) Pub. Date: Apr. 9, 2026

(54) IMAGE PROCESSING METHOD, IMAGE PROCESSING APPARATUS, AND LEARNING METHOD

(71) Applicant: Lasertec Corporation, Yokohama (JP)

(72) Inventor: Mizuki KOBAYASHI, Yokohama-shi (JP)

(21) Appl. No.: 19/349,572

(22) Filed: Oct. 3, 2025

(30) Foreign Application Priority Data
Oct. 4, 2024 (JP) 2024-175150

(51) Int. Cl. G06T 7/00

(52) U.S. Cl. CPC G06T 7/001; G06T 7/0006; G06T 2207/20081; G06T 2207/30148

(57) ABSTRACT

An image processing method includes: a process of acquiring an inspection image, which is an image captured by illuminating, by critical illumination, an inspection target area of an object to be inspected; a process of acquiring illumination profile information indicating an illumination profile at the time of image capturing; a process of generating a reference image based on design information of the object to be inspected; and a process of inspecting the inspection target area by comparing the inspection image with the reference image, in which, in the process of generating the reference image, by using the illumination profile information, different reference images are generated for areas that show a common structure in the design information.

### INCORPORATION BY REFERENCE

This application is based upon and claims the benefit of priority from Japanese patent application No. 2024-175150, filed on October 04, 2024, the disclosure of which is incorporated herein in its entirety by reference for all purposes.

### BACKGROUND

The present disclosure relates to an image processing method, an image processing apparatus, and a learning method.

One known method for inspecting an object such as a photomask manufactured based on design information is a so-called Die to Database (DDB) inspection in which a captured image of this object is compared with a reference image generated from design information of this object. With regard to this inspection, Patent Literature 1 discloses a technique for generating a reference image using a model learned by associating a process fluctuation amount with a captured image for learning.

[Patent Literature 1] International Patent Publication No. WO 2019/216303

### SUMMARY

Incidentally, there are various illumination systems of an apparatus used to image an object, and there are also various kinds of parameters indicating the state of this apparatus. Using all kinds of these parameters for a configuration of an image generation model is not preferable in terms of an increase in the processing load, and so on. It is therefore preferable to select, according to characteristics of the apparatus, parameters to be used to configure an image generation model capable of outputting a reference image in consideration of a state of the apparatus.

The inventors have found that, in an apparatus that uses a critical illumination optical system in order to image an object, a luminance distribution of a captured image fluctuates due to a fluctuation in the position of a bright spot. It is therefore required to provide a model capable of generating a reference image in view of this point.

The present disclosure has been made in view of the aforementioned circumstances, and provides a novel image processing method and so on capable of contributing to achieving an inspection that uses a reference image taking into consideration a bright spot fluctuation in an apparatus that uses a critical illumination optical system.

An image processing method according to one aspect of the present disclosure includes: a process of acquiring an inspection image, which is an image captured by illuminating, by critical illumination, an inspection target area of an object to be inspected; a process of acquiring illumination profile information indicating an illumination profile at the time of image capturing; a process of generating a reference image based on design information of the object to be inspected and a process of inspecting the inspection target area by comparing the inspection image with the reference image, in which, in the process of generating the reference image, by using the illumination profile information, different reference images are generated for areas that show a common structure in the design information.

In the aforementioned image processing method, in the process of generating the reference image, the reference image may be generated by inputting a design image which is based on the design information and the illumination profile information regarding the inspection image to a machine learning model that is learned in advance.

In the aforementioned image processing method, the machine learning model may be a model that is learned using learning data, which is a set of a learning image, which is an image captured by illuminating a learning sample by critical illumination, a sample design image, which is an image of the learning sample drawn in accordance with design information of the learning sample, and illumination profile information indicating an illumination profile when the learning image is captured.

In the aforementioned image processing method, in the process of generating the reference image, a design image which is based on the design information may be corrected, by an optical simulation that uses the illumination profile information regarding the inspection image, to a design image on which the illumination profile information is reflected, and the reference image may be generated by inputting the corrected design image to a machine learning model learned in advance.

In the aforementioned image processing method, the machine learning model may be a model that is learned using learning data, which is a set of a learning image, which is an image captured by illuminating a learning sample by critical illumination, and a sample design image, which is an image of the learning sample drawn in accordance with design information of the learning sample.

In the aforementioned image processing method, in the process of generating the reference image, the reference image may be generated by inputting a design image which is based on the design information to one of a plurality of machine learning models learned in advance that has been selected based on the illumination profile information regarding the inspection image.

In the aforementioned image processing method, each of the plurality of machine learning models may be a model that is learned using learning data, which is a set of a learning image, which is an image captured by illuminating a learning sample by critical illumination, and a sample design image which is based on design information of the learning sample, and in the learning data used for the learning, a characteristic of an illumination profile of the critical illumination may be different for each of the machine learning models.

In the aforementioned image processing method, in the process of acquiring the inspection image, the inspection image captured by using a first detector may be acquired, the first detector may be a TDI sensor that has image pickup elements arranged in a first direction and a second direction and accumulates electrical charges from the plurality of respective image pickup elements arranged in the second direction, and the illumination profile information may indicate a luminance intensity distribution of illumination light in the first direction.

In the aforementioned image processing method, in the process of acquiring the inspection image, the inspection image captured by using a first detector may be acquired, and the illumination profile information may be an image obtained by capturing, by a second detector, an image obtained by imaging light from a light source.

In the aforementioned image processing method, the illumination profile information may be an image obtained by capturing, by the second detector, an image obtained by imaging a part of illumination light that reaches a target to be imaged by the first detector from the light source.

An image processing apparatus according to one aspect of the present disclosure includes: an image acquisition unit configured to acquire an inspection image, which is an image captured by illuminating, by critical illumination, an inspection target area of an object to be inspected; a profile acquisition unit configured to acquire illumination profile information indicating an illumination profile at the time of image capturing; a reference image generation unit configured to generate a reference image based on design information of the object to be inspected; and an inspection unit configured to inspect the inspection target area by comparing the inspection image with the reference image, in which the reference image generation unit generates different reference images for areas that show a common structure in the design information by using the illumination profile information.

In the aforementioned image processing apparatus, the reference image generation unit may generate the reference image by inputting a design image which is based on the design information and the illumination profile information regarding the inspection image to a machine learning model that is learned in advance.

In the aforementioned image processing apparatus, the machine learning model may be a model that is learned using learning data, which is a set of a learning image, which is an image captured by illuminating a learning sample by critical illumination, a sample design image, which is an image of the learning sample drawn in accordance with design information of the learning sample, and illumination profile information indicating an illumination profile when the learning image is captured.

In the aforementioned image processing apparatus, the reference image generation unit may correct, by an optical simulation that uses the illumination profile information regarding the inspection image, a design image which is based on the design information to a design image on which the illumination profile information is reflected, and the reference image may be generated by inputting the corrected design image to a machine learning model learned in advance.

In the aforementioned image processing apparatus, the machine learning model may be a model that is learned using learning data, which is a set of a learning image, which is an image captured by illuminating a learning sample by critical illumination, and a sample design image, which is an image of the learning sample drawn in accordance with design information of the learning sample.

In the aforementioned image processing apparatus, the reference image generation unit may generate the reference image by inputting a design image which is based on the design information to one of a plurality of machine learning models learned in advance that has been selected based on the illumination profile information regarding the inspection image.

In the aforementioned image processing apparatus, each of the plurality of machine learning models may be a model that is learned using learning data, which is a set of a learning image, which is an image captured by illuminating a learning sample by critical illumination, and a sample design image which is based on design information of the learning sample, and in the learning data used for the learning, a characteristic of an illumination profile of the critical illumination may be different for each of the machine learning models.

In the aforementioned image processing apparatus, the image acquisition unit may acquire the inspection image captured by using a first detector, the first detector may be a TDI sensor that has image pickup elements arranged in a first direction and a second direction and accumulates electrical charges from the plurality of respective image pickup elements arranged in the second direction, and the illumination profile information may indicate a luminance intensity distribution of illumination light in the first direction.

In the aforementioned image processing apparatus, the image acquisition unit may acquire the inspection image captured by using a first detector, and the illumination profile information may be an image obtained by capturing, by a second detector, an image obtained by imaging light from a light source.

In the aforementioned image processing apparatus, the illumination profile information may be an image obtained by capturing, by the second detector, an image obtained by imaging a part of illumination light that reaches a target to be imaged by the first detector from the light source.

A learning method according to one aspect of the present disclosure includes: a process of acquiring learning data, which is a set of a learning image, which is an image captured by illuminating a learning sample by critical illumination, a sample design image which is based on design information of the learning sample, and illumination profile information indicating an illumination profile when the learning image is captured; and a process of generating, by performing machine learning by using the learning data, a machine learning model which receives a target design image and illumination profile information indicating an illumination profile when an inspection image is captured as input and outputs a reference image, in which the target design image is an image of an inspection target area of an object to be inspected drawn in accordance with design information of the object to be inspected, the inspection image is an image captured by illuminating, by critical illumination, the inspection target area of the object to be inspected, and the reference image is an image that is compared with the inspection image to inspect the inspection target area.

A learning method according to one aspect of the present disclosure includes: a process of acquiring at least: first learning data, which is a set of a first learning image, which is an image captured by illuminating a learning sample by critical illumination and which is in an area where an illumination profile has a first feature, and a sample design image which is based on design information of the learning sample; second learning data, which is a set of a second learning image, which is an image captured by illuminating the learning sample by critical illumination and which is in an area where an illumination profile has a second feature, and the sample design image; a process of generating a first machine learning model that receives a target design image as input and outputs a first reference image by performing machine learning by using the first learning data and generating a second machine learning model that receives the target design image as input and outputs a second reference image by performing machine learning by using the second learning data, in which the target design image is an image of an inspection target area of an object to be inspected drawn in accordance with design information of the object to be inspected, the first reference image and the second reference image are images to be compared with an inspection image to inspect the inspection target area, and the inspection image is an image captured by illuminating, by critical illumination, the inspection target area of the object to be inspected.

According to the present disclosure, it is possible to provide a novel image processing method and so on capable of contributing to achieving an inspection that uses a reference image taking into consideration a bright spot fluctuation in an apparatus that uses a critical illumination optical system.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram showing a configuration of an inspection system according to an embodiment;

FIG. 2 is a block diagram showing one example of a configuration of an image processing apparatus according to the embodiment;

FIG. 3 is a schematic diagram showing a correspondence relationship between an inspection image and illumination profile information;

FIG. 4 is a schematic diagram showing generation of a reference image by a reference image generation unit according to a first embodiment;

FIG. 5 is a flowchart showing one example of a flow of an inspection operation in the image processing apparatus according to the embodiment;

FIG. 6 is a schematic diagram showing generation of a reference image by a reference image generation unit according to a second embodiment;

FIG. 7 is a schematic diagram showing generation of a reference image by a reference image generation unit according to a third embodiment;

FIG. 8 is a graph showing one example of a luminance intensity distribution obtained by a second detector;

FIG. 9 is a schematic diagram showing a configuration example of an imaging apparatus according to a modified example; and

FIG. 10 is a block diagram showing one example of a configuration of a computer that implements processing in the image processing apparatus according to the embodiment.

### DESCRIPTION OF EMBODIMENTS

Hereinafter, with reference to the drawings, specific configurations of embodiments will be described. For the sake of clarification of the description, the following descriptions and the drawings are omitted and simplified as appropriate. In each drawing, the same or corresponding elements have the same reference numerals. Repeated descriptions are omitted as necessary for clarity. Each of the drawings is merely an example for describing one or more embodiments. Each of the drawings is not associated with only one particular embodiment and may instead be associated with one or more other embodiments. Those skilled in the art will appreciate that various features or steps described with reference to any one of the drawings may be combined with features or steps shown in one or more other drawings in order to produce, for example, embodiments that are not explicitly illustrated or described. Not all the features or steps shown in any one of the figures to describe illustrative embodiments are necessary, and some of the features or steps may be omitted. The order of the steps shown in any one of the figures may be changed as appropriate.

### [First Embodiment]

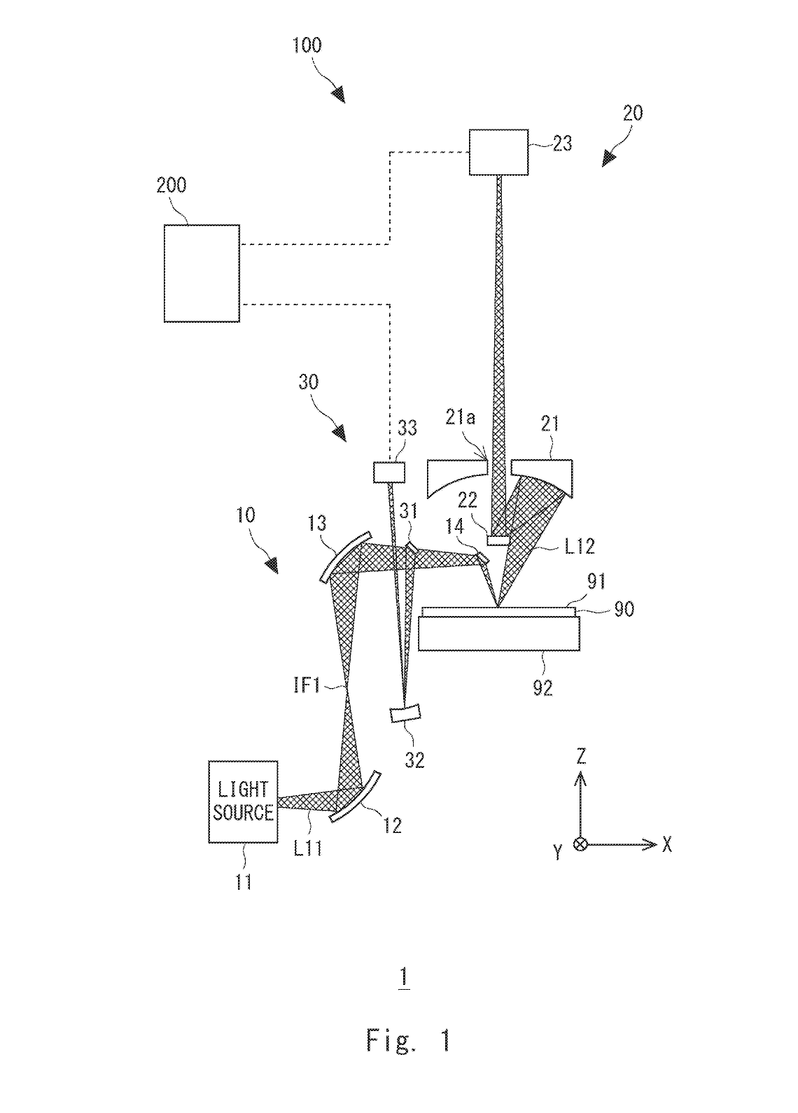

An inspection system according to a first embodiment will be described. FIG. 1 is a schematic diagram showing a configuration of an inspection system according to the embodiment. An inspection system 1 according to this embodiment, which includes an imaging apparatus 100 and an image processing apparatus 200, is used to inspect a sample such as a photomask used in a semiconductor manufacturing process. As shown in FIG. 1, the inspection system 1 is configured as an apparatus for inspecting an object to be inspected by illuminating illumination light onto a sample 90, which is an object to be inspected, and imaging this object to be inspected.

In particular, in this embodiment, the inspection system 1 is used to perform die-to-database inspection. More specifically, the inspection system 1 inspects the object to be inspected by comparing, by the image processing apparatus 200, a reference image generated by the image processing apparatus 200 with a captured image of the object to be inspected captured by the imaging apparatus 100. The reference image is a non-defective image generated based on design information of the object to be inspected.

Hereinafter, the imaging apparatus 100 will be described first, and then the image processing apparatus 200 will be specifically described. Note that the imaging apparatus 100 may be referred to as an optical apparatus.

The sample 90, which is an inspection target of the inspection system 1, is, for example, an Extreme Ultraviolet (EUV) mask, and the imaging apparatus 100 illuminates EUV light onto the sample 90. The sample 90 is not limited to the EUV mask, and may be various kinds of photomasks designed for light having a wavelength longer than that of the EUV light or light having a wavelength shorter than that of the EUV light, or various kinds of members in which fine patterns are formed, such as a semiconductor wafer in which a circuit pattern is formed.

The imaging apparatus 100 includes an illumination optical system 10, a detection optical system 20, and a monitor unit 30. The illumination optical system 10 includes a light source 11, an ellipsoidal mirror 12, an ellipsoidal mirror 13, and a dropping mirror 14. The detection optical system 20 includes a holed concave mirror 21, a convex mirror 22, and a first detector 23. The holed concave mirror 21 and the convex mirror 22 form a Schwarzschild magnification optical system. The monitor unit 30 includes a cut mirror 31, a concave mirror 32, and a second detector 33.

The light source 11 emits, as illumination light L11, EUV light having a wavelength of 13.5 nm, which is the same wavelength as an exposure wavelength for the EUV mask, i.e., for the sample 90. The illumination light L11 is not limited to the EUV light, and may be light having another wavelength depending on the sample 90. The illumination light L11 emitted from the light source 11 is reflected on the ellipsoidal mirror 12. The illumination light L11 reflected on the ellipsoidal mirror 12 is concentrated at a focal point IF1 positioned in a place conjugate with an upper surface 91 of the sample 90, and is then incident on a reflecting mirror such as the ellipsoidal mirror 13 while spreading.

The illumination light L11 incident on the ellipsoidal mirror 13 is reflected thereon. The illumination light L11 reflected on the ellipsoidal mirror 13 is incident on the dropping mirror 14 while being converged. That is, the ellipsoidal mirror 13 makes the illumination light L11 incident on the dropping mirror 14 as converged light. The dropping mirror 14 is disposed right above the sample 90. The illumination light L11, which has been incident on the dropping mirror 14 and reflected thereon, is incident on the sample 90. That is, the dropping mirror 14 makes the illumination light L11 incident on the sample 90.

The ellipsoidal mirror 13 is designed and disposed so as to concentrate the illumination light L11 onto the sample 90. The illumination optical system 10 is disposed in such a way that an image of the light source 11 (an image of a bright spot) is formed on the upper surface 91 of the sample 90 when the illumination light L11 illuminates the sample 90. Therefore, the illumination optical system 10 provides critical illumination. In this way, the illumination optical system 10 illuminates the inspection target by using the critical illumination by the illumination light L11 generated by the light source 11.

The sample 90 is disposed on a stage 92. Note that a plane parallel to the upper surface 91 of the sample 90 is defined as an XY-plane and a direction perpendicular to the XY plane is defined as a Z direction. The illumination light L11 enters (i.e., incident on) the sample 90 in a direction inclined from the Z direction. That is, the illumination light L11 obliquely enters (i.e., is obliquely incident on) the sample 90 and illuminates the sample 90.

The stage 92 is an XYZ-drive stage. By moving the stage 92 in the XY directions, a desired area on the sample 90 can be illuminated. Further, a focus can be adjusted by moving the stage 92 in the Z direction. The stage 92 may be rotated about at least one of XYZ axes.

The illumination light L11 emitted from the light source 11 illuminates an inspection area on the sample 90. The inspection area illuminated by the illumination light L11 is, for example, an area of 0.5 mm square. The light that has been incident on the sample 90 from the direction inclined from the Z direction and has been obtained from the sample 90 based on the incidence of the illumination light L11, for example, the reflected light L12, is incident on the holed concave mirror 21. A hole 21a is formed at the center of the holed concave mirror 21. While the light obtained from the sample 90 based on the incidence of the illumination light L11 will be referred to as reflected light L12 hereinafter, this light may be diffracted light, scattered light, fluorescence, or the like.

The reflected light L12 reflected on the holed concave mirror 21 is incident on the convex mirror 22. The convex mirror 22 reflects the reflected light L12 coming from the holed concave mirror 21 toward the hole 21a of the holed concave mirror 21. The reflected light L12, which has passed through the hole 21a, is detected by the first detector 23. The first detector 23, which is a detector that includes a Time Delay Integration (TDI) sensor, acquires image data of the sample 90, which is the inspection target. More specifically, the first detector 23 is a TDI sensor that includes image pickup elements arranged in a first direction and a second direction and accumulates electrical charges from the plurality of respective image pickup elements arranged in the second direction. The first direction is, for example, the X direction and the second direction is, for example, the Y direction. This TDI sensor transfers electrical charges in the second direction (Y direction), thereby accumulating electrical charges of a row of plurality of image pickup elements that are arranged in the second direction (that is, a plurality of image pickup elements whose positions in the first direction are the same). Accordingly, one-dimensional image data for the first direction is acquired. The first detector 23 includes, in the first direction, a plurality of rows of image pickup elements arranged in the second direction, thereby acquiring a plurality of pieces of one-dimensional image data. By coupling the plurality of pieces of one-dimensional image data, two-dimensional image data is generated. The image pickup elements are, for example, but not limited to, Charge Coupled Devices (CCDs).

As described above, the detection optical system 20 concentrates the reflected light L12 from the sample 90 illuminated by the illumination light L11, and acquires image data of the sample 90 by detecting the concentrated reflected light L12 by the first detector 23. The plurality of pieces of one-dimensional image data of the sample 90 acquired by the first detector 23 are output to the image processing apparatus 200 and processed as two-dimensional image data.

As shown in FIG. 1, the cut mirror 31 of the monitor unit 30 is disposed between the ellipsoidal mirror 13 and the dropping mirror 14, and takes out part of the illumination light L11 between the ellipsoidal mirror 13 and the dropping mirror 14. The cut mirror 31 reflects a small part of the beam of the illumination light L11 so that the small part is cut out from the illumination light L11. The part of the beam is, for example, an upper part of the beam.

In a cross-sectional area of a cross section of the illumination light L11 perpendicular to an optical axis thereof at a place where the cut mirror 31 is disposed, a cross-sectional area of the part of the illumination light L11 reflected by the cut mirror 31 is smaller than that of the remaining part of the illumination light L11.

For example, when the cross-sectional area of the cross section perpendicular to the optical axis of the illumination light L11 at the place where the cut mirror 31 is disposed is 100, the cross-sectional area of the taken-out part is about 1. The angle for taking out the part of the illumination light L11 which is taken out from the light source 11 in the direction perpendicular to the optical axis is, for example, ±7°. The angle of the illumination light L11 used for the sample 90 is, for example, in the range of ±6°. Only the upper part of the beam of the illumination light L11 in the range of, for example, 1° is taken out by the cut mirror 31 in order to use it in the monitor unit 30. Even when the upper part of the beam is slightly taken out as described above, the amount of the illumination light L11 incident on the sample 90 barely decreases.

The cut mirror 31 is disposed in, for example, a place close to a pupil in the illumination optical system 10. By taking out the part of the illumination light L11 by the cut mirror 31 in the place close to the pupil in the illumination optical system 10, it is possible to obtain an excellent correlation between image data acquired by the first detector 23 and image data acquired by the second detector 33. Even when a Numerical Aperture (NA) for the first detector 23 differs from an NA for the second detector 33 and hence their Point Spread Functions (PSFs) differ from each other, the difference between the NAs has no adverse effect in this embodiment because the plasma size is sufficiently larger than the PSF size.

After the illumination light L11, which has been reflected on the cut mirror 31, is concentrated at a focal point, this illumination light L11 is incident on the concave mirror 32 while spreading.

The illumination light L11, which has been incident on the concave mirror 32 and reflected thereon, is detected by the second detector 33. The second detector 33 is a detector including a TDI sensor and acquires image data which indicates a distribution of the intensity of the luminance of the illumination light L11. More specifically, the second detector 33 is, just like the first detector 23, a TDI sensor that includes image pickup elements arranged in a first direction and a second direction and accumulates electrical charges from the plurality of respective image pickup elements arranged in the second direction. The first direction is, for example, the X direction and the second direction is, for example, the Y direction. This TDI sensor transfers electric charges in the second direction (Y direction), thereby accumulating electrical charges of a row of plurality of image pickup elements that are arranged in the second direction (that is, a plurality of image pickup elements whose positions in the first direction are the same). Accordingly, one-dimensional image data for the first direction is acquired. The second detector 33 includes, in the first direction, a plurality of rows of image pickup elements arranged in the second direction, thereby acquiring a plurality of pieces of one-dimensional image data. The one-dimensional image data acquired by the second detector 33 indicates a distribution of an intensity of a luminance of the illumination light L11. By coupling the plurality of pieces of one-dimensional image data, two-dimensional image data is generated. The image pickup elements are, for example, but not limited to, CCDs.

For example, the illumination system of the monitor unit 30 may be configured so that an image of the light source 11 (an image of the bright spot) for the illumination light L11 is formed on the second detector 33. In this case, the first detector 23 is positioned in a place conjugate with the second detector 33. In this way, the monitor unit 30 can acquire image data indicating a luminance intensity distribution of the illumination light L11 that is detected by illuminating the second detector 33 by the critical illumination by using the part of the illumination light L11. The monitor unit 30 outputs the acquired image data of the luminance intensity distribution of the illumination light L11 to the image processing apparatus 200.

The image processing apparatus 200 is connected to the detection optical system 20 and the monitor unit 30 by a wire or wirelessly. The image processing apparatus 200 receives, from the first detector 23 in the detection optical system 20, two-dimensional image data formed of a plurality of pieces of one-dimensional image data of the object to be inspected. Further, the image processing apparatus 200 receives, from the second detector 33 in the monitor unit 30, two-dimensional image data formed of a plurality of pieces of one-dimensional image data of the luminance intensity distribution of the illumination light L11.

Incidentally, the present inventors have found that, when a critical illumination optical system is used for image capturing, the fluctuation in the position of the bright spot of the light source especially has a great influence on a luminance distribution of a captured image. In the imaging range on the upper surface 91 of the sample 90, it is preferable that the intensity of the illumination light L11 be ideally uniform and constant. However, in reality, the intensity of the illumination light L11 on the upper surface 91 of the sample 90 may vary depending on the position or time of imaging. In order to solve this problem, in this embodiment, processing focused on an illumination profile at the time of image capturing is performed by the image processing apparatus 200, thereby reducing the aforementioned influence. Hereinafter, the image processing apparatus 200 will be described.

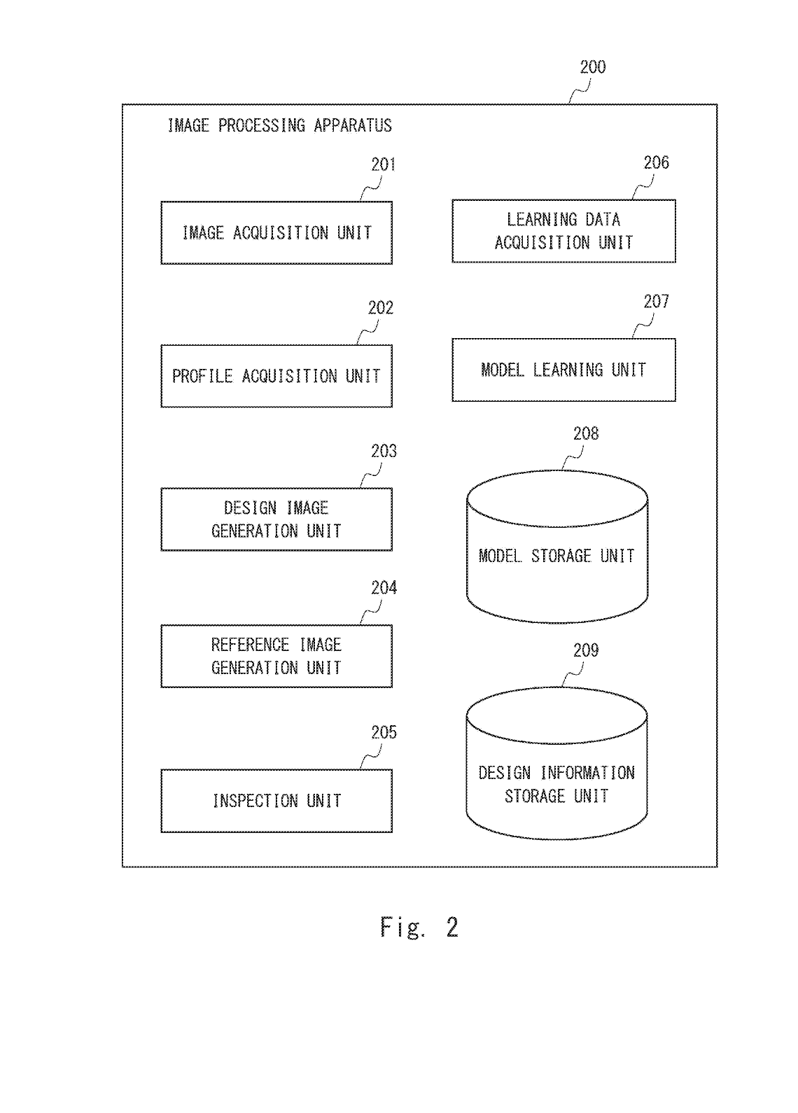

FIG. 2 is a block diagram showing one example of a configuration of the image processing apparatus 200. As shown in FIG. 2, the image processing apparatus 200 includes an image acquisition unit 201, a profile acquisition unit 202, a design image generation unit 203, a reference image generation unit 204, an inspection unit 205, a learning data acquisition unit 206, a model learning unit 207, a model storage unit 208, and a design information storage unit 209. While the image processing apparatus 200 includes components for generating machine learning models to be used for inspection of the object to be inspected and components that use the machine learning models in the example shown in FIG. 2, the components for generating the machine learning models and the components that use the machine learning models may belong to image processing apparatuses different from each other. The image processing apparatus may be referred to as an inspection apparatus or the like. Further, in particular, an image processing apparatus that includes components for generating the machine learning models may be referred to as a learning apparatus.

The image acquisition unit 201 acquires an inspection image, which is an image captured by illuminating, by critical illumination, the object to be inspected. More specifically, the inspection image is an image obtained by imaging the inspection target area of the object to be inspected. The inspection target area is, for example, a part of the area of the surface of the object to be inspected. In this embodiment, as one example, the image acquisition unit 201 acquires, from the aforementioned first detector 23, the two-dimensional image of the object to be inspected as the inspection image. That is, the image acquisition unit 201 acquires the inspection image captured using the first detector 23.

The profile acquisition unit 202 acquires illumination profile information indicating an illumination profile when the object to be inspected is imaged. The illumination profile indicates the state of the illumination that is used when the imaging target is captured, and more specifically, indicates a distribution of the intensity of the luminance on the surface of the imaging target. In this embodiment, as one example, the profile acquisition unit 202 acquires the aforementioned two-dimensional image from the second detector 33 as illumination profile information. Therefore, in the following description, the illumination profile information is also referred to as a profile image.

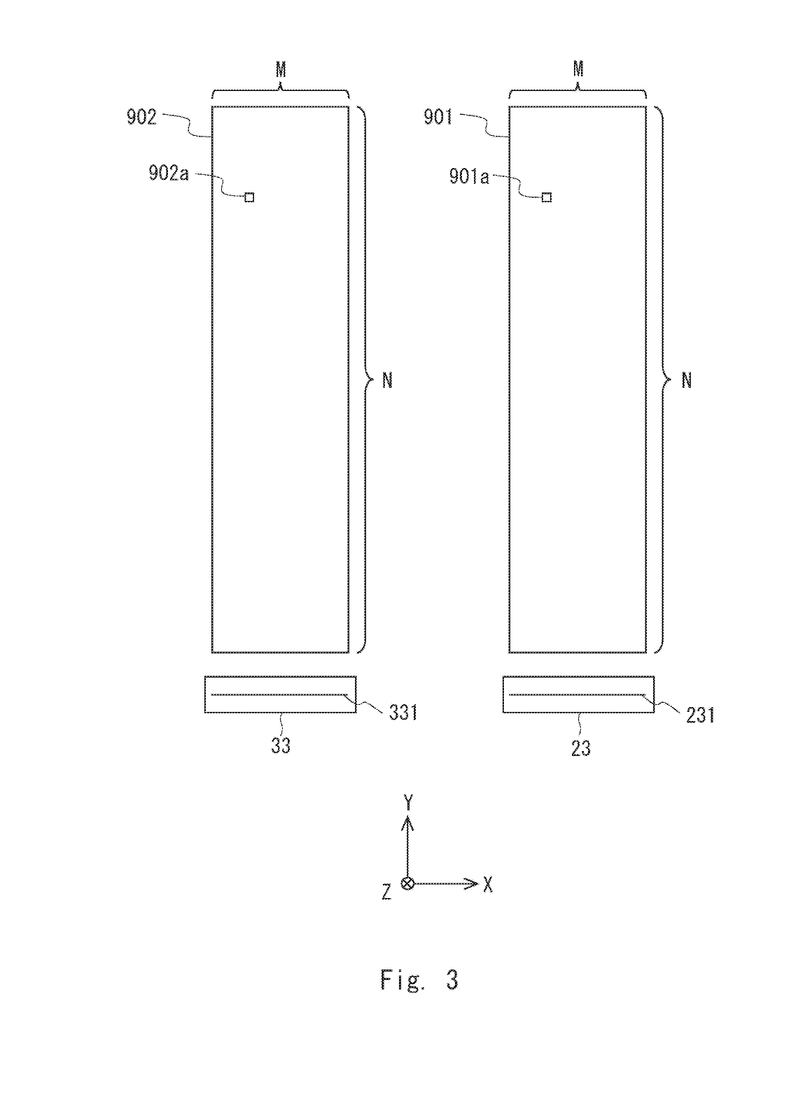

With reference to the drawings, the aforementioned inspection image and illumination profile information, which is an image, will be described. FIG. 3 is a schematic diagram showing a correspondence relationship between the inspection image and the illumination profile information (profile image). FIG. 3 also shows the first detector 23, a two-dimensional image 901 obtained by imaging by the first detector 23, the second detector 33, and a two-dimensional image 902 obtained by imaging by the second detector 33. As shown in FIG. 3, the two-dimensional image 901 can be obtained by performing scanning in the Y direction by a row of image pickup elements 231 aligned in the X direction of the first detector 23. Likewise, the two-dimensional image 902 can be obtained by performing scanning in the Y direction by a row of image pickup elements 331 aligned in the X direction of the second detector 33. More specifically, as described above, since the first detector 23 and the second detector 33 are TDI sensors, a plurality of rows of image pickup elements 231 or 331 are arranged in the Y direction. The two-dimensional image 901, which is an image whose X direction includes M (here M denotes a natural number) pixels and Y direction includes N (here N denotes a natural number) pixels, is a two-dimensional image of the inspection target area. The two-dimensional image 902, which is an image whose X direction includes M pixels and Y direction includes N pixels, is a two-dimensional image indicating an illumination profile when the two-dimensional image 901 is captured.

As shown in FIG. 3, for example, an inspection image 901a acquired by the image acquisition unit 201, which is a partial image cut out of the two-dimensional image 901, is an image including m (here m denotes a natural number) pixels in the X direction and n (here n denotes a natural number) pixels in the Y direction. Here, m and n are the same as the size of the reference image generated by the reference image generation unit 204 that will be described later. Further, as shown in FIG. 3, for example, the profile image 902a acquired by the profile acquisition unit 202 is also a partial image cut out of the two-dimensional image 902, and is an image whose X direction includes m pixels and Y direction includes n pixels. Then, as shown in FIG. 3, a relative position of the inspection image 901a with respect to the two-dimensional image 901 is the same as a relative position of the profile image 902a with respect to the two-dimensional image 902. In this embodiment, the image acquisition unit 201 and the profile acquisition unit 202 acquire the respective images described above. While the inspection image 901a acquired by the image acquisition unit 201 is described as a partial image of the two-dimensional image 901 in this embodiment, the image acquisition unit 201 may acquire the two-dimensional image 901 as the inspection image. In this case, the profile acquisition unit 202 may acquire the two-dimensional image 902 as illumination profile information.

The illumination profile information (profile image) acquired by the profile acquisition unit 202 is illumination profile information indicating the luminance intensity distribution of the illumination light in the first direction (X direction). Further, as described above, the image acquisition unit 201 acquires the inspection image captured by using the first detector 23. As described above, the first detector 23 is a TDI sensor that accumulates electrical charges from the plurality of respective image pickup elements arranged in the second direction (Y direction). Therefore, in this embodiment, the profile acquisition unit 202 can acquire appropriate information to take into consideration the fluctuation in the illumination light. This is because, since electrical charges are accumulated by the TDI sensor for the second direction, as described above, the influence of the fluctuation in the illumination light is reduced for the second direction. For example, even when the light source 11 fluctuates, the influence of the fluctuation in the light source 11 is reduced for the second direction due to the accumulation of electrical charges of the image pickup elements arranged in the second direction. On the other hand, such a reduction cannot be expected for the first direction. Therefore, when the TDI sensor is used as the first detector 23, it is preferable to acquire illumination profile information indicating the luminance intensity distribution of the illumination light in the first direction (X direction) in order to acquire an appropriate reference image in the reference image generation unit 204 that will be described later.

The design image generation unit 203 generates a design image, which is an image drawn in accordance with the design information of the object to be inspected. More specifically, the design image generation unit 203 generates a design image for the inspection target area of the object to be inspected (in particular, area corresponding to the inspection image 901a). Specifically, the design image generation unit 203 generates, for example, a design image of m×n pixels in accordance with the design information of the object to be inspected stored in the design information storage unit 209. The design information storage unit 209 stores design information of a desired sample including the object to be inspected. The design information may be, for example, vector data indicating a pattern formed in the sample. For example, the design image generation unit 203 performs rasterization processing based on the design information, and generates a binary image. Then, the design image generation unit 203 pixelates the binary image and generates a gray image having a predetermined number of gradations. This gray image is the design image. While the design image generation unit 203 generates a gray image obtained by pixelating the binary image as the design image in this embodiment, it may generate a binary image as the design image. When, for example, the design information storage unit 209 stores the design image in place of the design information or along with the design information, the image processing apparatus 200 may not include the design image generation unit 203. That is, in this case, the image processing apparatus 200 may use the stored design image, and does not need to generate the design image from the design information. The design information and the design image may be collectively referred to as design information without differentiating between them.

The reference image generation unit 204 generates a reference image from the design image. While the reference image generation unit 204 generates a reference image from the design image generated by the design image generation unit 203 in this embodiment, as described above, the reference image generation unit 204 may not necessarily use the design image generated by the design image generation unit 203 if the reference image can be acquired without generating the design image. The reference image is an image that is compared with the inspection image in order to inspect the inspection target area of the object to be inspected.

In particular, in this embodiment, the reference image generation unit 204 generates, by using the illumination profile information acquired by the profile acquisition unit 202, reference images different from each other for a first inspection image and a second inspection image, which are inspection images whose illumination profiles at the time of image capturing are different from each other. That is, when the illumination profile information items are different from each other even when the design image is the same, the reference image generation unit 204 generates reference images different from each other. That is, when the illumination profile information items are different from each other for areas showing a common structure in the design information, the reference image generation unit 204 generates reference images different from each other.

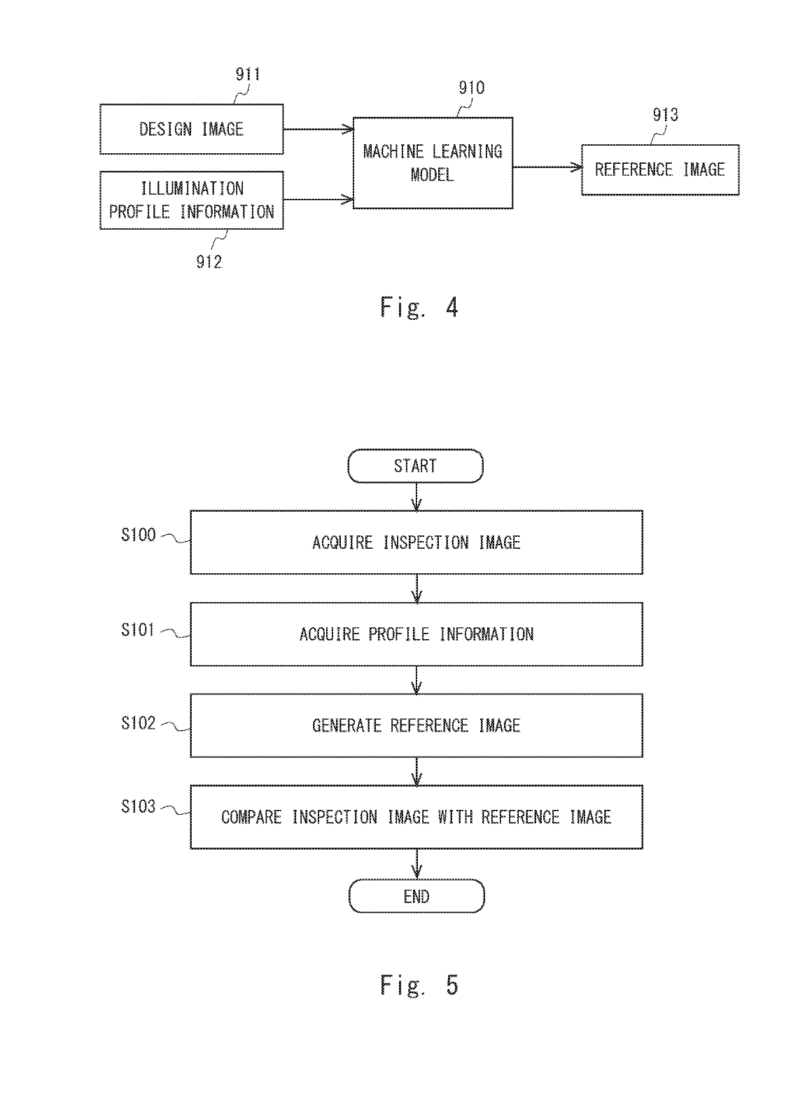

FIG. 4 is a schematic diagram showing generation of the reference image by the reference image generation unit 204 according to this embodiment. As shown in FIG. 4, specifically, in this embodiment, the reference image generation unit 204 generates a reference image 913 by inputting a design image 911, and illumination profile information 912 (profile image) regarding the inspection image to a machine learning model 910 that is learned in advance. That is, the reference image generation unit 204 generates the reference image by using the machine learning model that is learned in advance so as to receive the design image and the illumination profile information as input and output the reference image. It can also be said that this machine learning model 910 is a model in which the influence of properties of the imaging apparatus 100, properties of the process of manufacturing the object to be inspected (e.g., lithography process), or the like on the captured image by the imaging apparatus 100 and the influence of the difference in the illumination profile at the time of image capturing on the captured image are reflected on the image input to the model. Note that the reference image generation unit 204 uses a machine learning model that is learned in advance by the model learning unit 207. The learning of the model by the model learning unit 207 will be described later.

The inspection unit 205 inspects, by comparing the inspection image with the reference image, the presence or absence of an abnormality of the inspection target area of the object to be inspected. The inspection unit 205 compares the inspection image acquired by the image acquisition unit 201 with the reference image generated by the reference image generation unit 204. For example, the inspection unit 205 obtains a difference value of a gradation value (luminance) between the reference image and the inspection image and compares the difference value with a threshold. The inspection unit 205 detects a pattern abnormality, a defect or the like by the result of comparing the difference value with the threshold. That is, the part where the pattern abnormality has occurred is, for example, a part where a foreign matter has adhered, and in this part, the difference value becomes greater than the threshold. The inspection unit 205 outputs an inspection result. The inspection unit 205 outputs, for example, an inspection result indicating the presence or absence of an abnormality. The inspection unit 205 may output information on an abnormal part in association with its position coordinates. The inspection unit 205 may display the inspection result on a display as output, or may transmit the inspection result to another apparatus. Note that the inspection unit 205 may compare images by units of M×N pixels shown in FIG. 3. In this case, the image acquisition unit 201 sequentially cuts out the inspection image 901a from the two-dimensional image 901 (see FIG. 3) of M×N pixels until all the areas of the two-dimensional image 901 are covered. Further, the profile acquisition unit 202 also sequentially cuts out, of the two-dimensional image 902 (see FIG. 3), the profile image 902a corresponding to the inspection image 901a that is cut out. The design image generation unit 203 further generates a design image for each inspection image 901a. Then, the reference image generation unit 204 generates a reference image for each inspection image 901a. That is, the reference image generation unit 204 repeats, by using the design image corresponding to the inspection image 901a and the profile information (profile image) corresponding to the inspection image 901a, processing for generating a reference image of m×n pixels corresponding to the inspection image 901a. After that, the inspection unit 205 compares the two-dimensional image 901 of M×N pixels with the reference image of M×N pixels formed by connecting the plurality of reference images of m×n pixels.

Next, a flowchart of a flow of an operation of the aforementioned image processing apparatus 200 will be shown. FIG. 5 is a flowchart showing one example of a flow of an inspection operation in the image processing apparatus 200. Hereinafter, with reference to FIG. 5, a flow of an operation for inspecting the object to be inspected will be described.

In Step S100, the image acquisition unit 201 acquires an inspection image of an object to be inspected. Next, in Step S101, the profile acquisition unit 202 acquires the illumination profile information (profile image) indicating the illumination profile when the inspection image is captured acquired in Step S100. Next, in Step S102, the reference image generation unit 204 generates a reference image using a design image and profile information. Prior to this step, if necessary, the design image generation unit 203 generates the design image from design information. After Step S102, in Step S103, the inspection unit 205 compares the inspection image with the reference image, thereby inspecting the object to be inspected.

Next, the machine learning model used by the reference image generation unit 204 will be described. In this embodiment, as an example, a deep learning model is used as the machine learning model.

The learning data acquisition unit 206 acquires learning data used for machine learning of a model used by the reference image generation unit 204. The learning data acquisition unit 206 may acquire learning data input from another apparatus, or may acquire learning data by reading out learning data stored in a storage apparatus such as a memory 502, which will be described later, of the image processing apparatus 200. The learning data acquired by the learning data acquisition unit 206 is data formed of a set of a learning image, which is an image captured by illuminating a learning sample by critical illumination, a sample design image, which is an image of the learning sample drawn in accordance with design information of the learning sample, and learning profile information, which is illumination profile information indicating the illumination profile at the time of image capturing of the learning image. The learning sample is, for example, a sample manufactured through a manufacturing process similar to that of the object to be inspected. The learning sample may be a sample in which a pattern used only for learning is formed (that is, a sample whose pattern is different from that of the object to be inspected on which inspection is actually performed) or may be the object to be inspected on which inspection is actually performed.

The learning image is captured by the first detector 23. Therefore, the learning data acquisition unit 206 may acquire the learning image via the image acquisition unit 201. Like the inspection image 901a (see FIG. 3), the learning image is, for example, a two-dimensional image of m×n pixels cut out of the two-dimensional image obtained by the first detector 23.

Further, in this embodiment, the learning profile information is a profile image, and is an image captured by the second detector 33. Therefore, the learning data acquisition unit 206 may acquire learning profile information via the profile acquisition unit 202. Like the profile image 902a (see FIG. 3), the learning profile information is, for example, a two-dimensional image of m×n pixels cut out of the two-dimensional image obtained by the second detector 33. Note that the relative position of the learning image with respect to the original two-dimensional image of which the image is cut out is the same as the relative position of the learning profile information (profile image) with respect to the original two-dimensional image of which the image is cut out.

The sample design image is a design image for an area indicated in the learning image, and is an image generated from design information in a method similar to that when the design image used for the inspection is generated. In this embodiment, specifically, the sample design image is a gray image obtained by pixelating a binary image generated by performing rasterization processing based on the design information. Accordingly, the learning data acquisition unit 206 may acquire a sample design image via the design image generation unit 203. Therefore, the design information storage unit 209 may store design information of the learning sample.

The model learning unit 207 performs machine learning by using the learning data acquired by the learning data acquisition unit 206, thereby generating the machine learning model. Accordingly, the model learning unit 207 generates the machine learning model by performing learning processing by using learning data, which is a set of a learning image, which is an image captured by illuminating a learning sample by critical illumination, a sample design image, which is an image of the learning sample drawn in accordance with design information of the learning sample, and illumination profile information indicating the illumination profile when the learning image is captured. This machine learning model is a model used by the aforementioned reference image generation unit 204. That is, the machine learning model generated by the model learning unit 207 is a model that receives a design image of the object to be inspected and illumination profile information indicating the illumination profile when the inspection image is captured as input and outputs a reference image. The learned model generated by the machine learning processing of the model learning unit 207 is stored in the model storage unit 208. Then, the reference image generation unit 204 generates a reference image using the learned model stored in the model storage unit 208. That is, the learned model generated by the model learning unit 207 is used as a computer program module for functioning a computer to generate the reference image.

The first embodiment has been described above. In this embodiment, the reference image is generated taking into consideration the illumination profile at the time of image capturing. Therefore, a more appropriate reference image can be generated. In particular, in this embodiment, the reference image is generated with a focus on the illumination profile, which is a parameter suitable for the inspection where the imaging apparatus that uses the critical illumination optical system is used. It is therefore possible to generate a reference image that is suitable for inspection where an imaging apparatus that uses a critical illumination optical system is used. It is sufficient that the illumination profile information used in this embodiment indicate the illumination profile when the inspection image is captured, and may not necessarily be a profile image acquired by the second detector 33.

### [Second Embodiment]

Next, a second embodiment will be described. A method for generating a reference image using a design image and illumination profile information in this embodiment is different from that in the first embodiment. Hereinafter, a configuration or an operation of the second embodiment that is different from that in the first embodiment will be described, and descriptions that are redundant with those in the first embodiment will be omitted as appropriate.

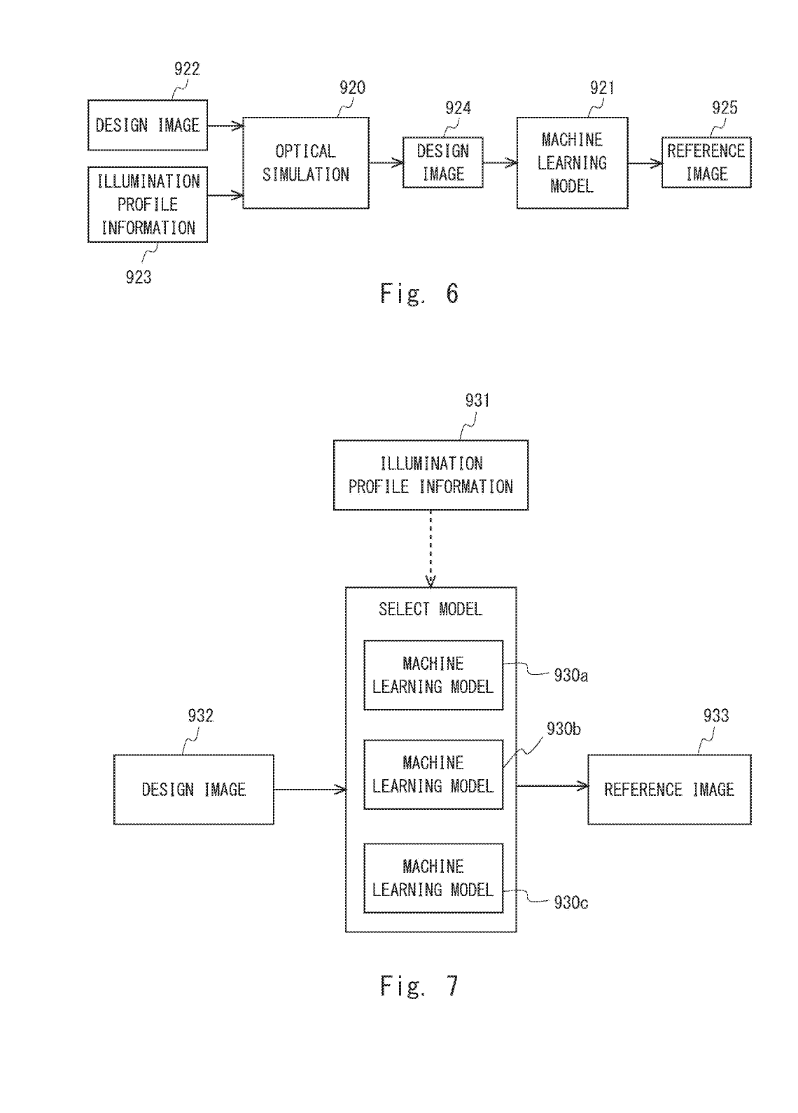

FIG. 6 is a schematic diagram showing generation of a reference image by a reference image generation unit 204 according to the second embodiment. As shown in FIG. 6, in this embodiment, the reference image generation unit 204 corrects, by an optical simulation 920 that uses illumination profile information 923 regarding an inspection image, a design image 922 to a design image 924 on which the illumination profile information 923 is reflected. The design image 922 is an image of an inspection target area drawn in accordance with design information of an object to be inspected, and is, for example, an image generated by the design image generation unit 203. The reference image generation unit 204 generates a reference image 925 by correcting the design image 922 to the design image 924 and then inputting the corrected design image 924 to a machine learning model 921 learned in advance. The optical simulation 920 is a simulator (software) that simulates the captured image corresponding to the design image 922 based on the optical design of the imaging apparatus 100 (the shape or arrangement of a mirror and a lens, lens magnification, or the like) and the illumination profile information, which are parameters. Known software may be used as a simulator that implements the optical simulation 920.

As described above, since the optical simulation 920 using the illumination profile information is performed in this embodiment, the illumination profile information is reflected on the corrected design image 924. Therefore, the machine learning model 921 according to this embodiment does not require illumination profile information as input, unlike the machine learning model that is used in the first embodiment. That is, in this embodiment, the reference image generation unit 204 generates a reference image using a machine learning model that is learned in advance to receive the design image and output the reference image.

The machine learning model 921 according to this embodiment is a model that is learned using learning data formed of a set of the learning image described in the first embodiment and the sample design image described in the first embodiment. The model learning unit 207 according to this embodiment generates the machine learning model 921 using the aforementioned learning data. In this way, in this embodiment, unlike the first embodiment, the machine learning model 921 in which learning has been performed not taking into consideration an illumination profile is used. It can be said that this machine learning model 921 is a model in which the influence of properties of the imaging apparatus 100, properties of the process of manufacturing the object to be inspected (e.g., lithography process), or the like on the captured image by the imaging apparatus 100 is reflected on the image input to the model. As described above, the influence of the difference in the illumination profile at the time of image capturing on the captured image of the imaging apparatus 100 is reflected on the design image 924 by the optical simulation 920. In this embodiment as well, when illumination profile information items are different from each other even when the design image is the same, the reference image generation unit 204 generates reference images different from each other.

The second embodiment has been described above. In this embodiment as well, the reference image is generated taking into consideration the illumination profile at the time of image capturing. Therefore, a more appropriate reference image can be generated. In this embodiment as well, it is sufficient that the illumination profile information indicate the illumination profile when the inspection image is captured, and may not necessarily be a profile image acquired by the second detector 33.

### [Third Embodiment]

Next, a third embodiment will be described. In this embodiment as well, a method for generating a reference image using a design image and illumination profile information is different from that in the first embodiment. Here, a configuration or an operation that is different from that in the first embodiment will be described, and descriptions that are redundant with those in the first embodiment will be omitted as appropriate.

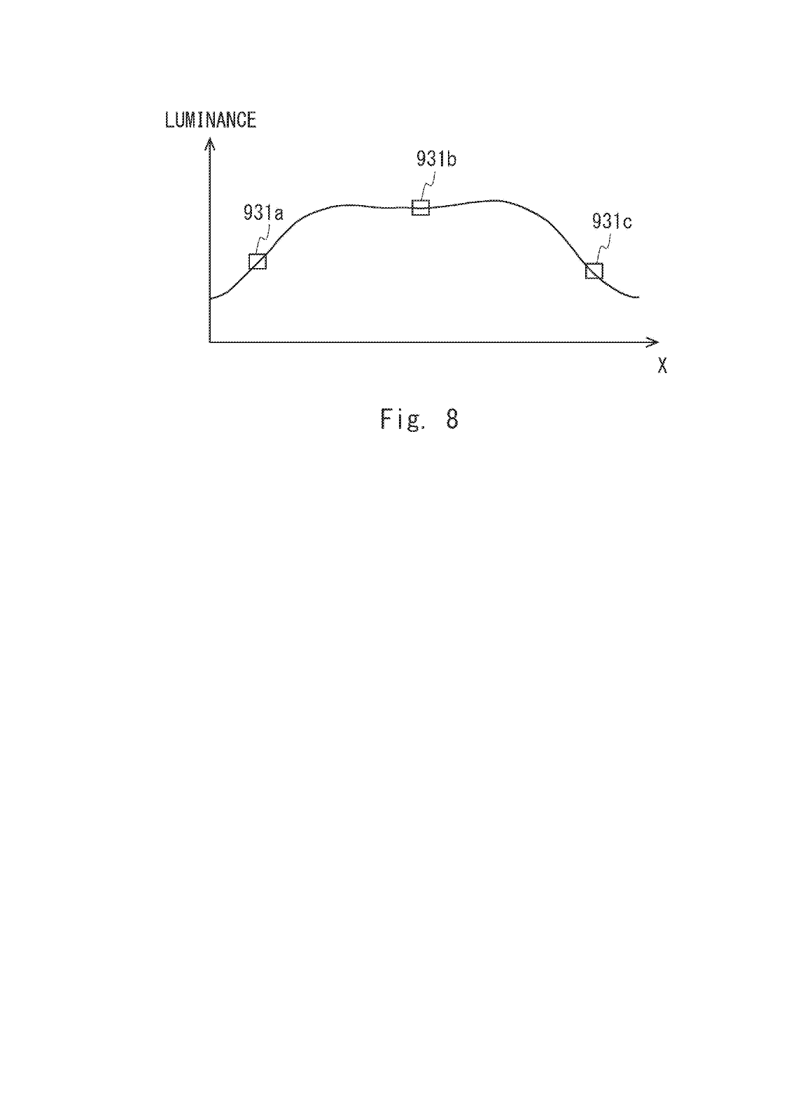

FIG. 7 is a schematic diagram showing generation of a reference image by a reference image generation unit 204 according to the third embodiment. As shown in FIG. 7, in this embodiment, the reference image generation unit 204 generates a reference image 933 by inputting a design image 932 to one of a plurality of machine learning models learned in advance that has been selected based on illumination profile information 931 for an inspection image. In this embodiment, as one example, the reference image generation unit 204 selectively uses three machine learning models 930a, 930b, and 930c based on the illumination profile information 931. Hereinafter, with reference to FIG. 8, selective use of the models based on the illumination profile information 931 will be specifically described.

FIG. 8 is a graph showing one example of a luminance intensity distribution obtained by the second detector 33. While the graph shown in FIG. 8 shows the intensity of the luminance in each imaging position in the imaging range of the second detector 33, this graph also corresponds to the intensity of the luminance in each imaging position in the imaging range of the first detector 23. In this embodiment, the illumination profile information is classified into three patterns. The first pattern of the illumination profile information has such a characteristic that the luminance intensity increases as the coordinate values of the imaging position increase, like in illumination profile information 931a shown in FIG. 8. Further, the second pattern of the illumination profile information has such a characteristic that the luminance intensity is constant regardless of the coordinate values of the imaging position, like in illumination profile information 931b shown in FIG. 8. The constant here means substantially constant, and means that the fluctuation in the luminance intensity due to the coordinate values of the imaging position is within a predetermined allowable fluctuation range. Further, the third pattern of the illumination profile information has such a characteristic that the luminance intensity decreases as the coordinate values of the imaging position increase, like illumination profile information 931c shown in FIG. 8.

In this embodiment, the machine learning model 930a shown in FIG. 7 is a model that is used when the illumination profile information 931 used to generate the reference image belongs to the aforementioned first pattern. Likewise, the machine learning model 930b is a model that is used when the illumination profile information 931 used to generate the reference image belongs to the aforementioned second pattern, and the machine learning model 930c is a model that is used when the illumination profile information 931 used to generate the reference image belongs to the aforementioned third pattern.

The machine learning model 930a is a model that is learned in advance using first learning data, which is a set of a first learning image, which is an image captured by illuminating a learning sample by critical illumination and has an illumination profile that belongs to the first pattern, and a sample design image, which is an image of the learning sample drawn in accordance with design information of the learning sample. The first learning image, which is captured by illuminating a learning sample by critical illumination, is an image which is in an area where the illumination profile has a first feature. Further, the machine learning model 930b is a model that is learned in advance using second learning data, which is a set of a second learning image, which is an image captured by illuminating a learning sample by critical illumination and has an illumination profile that belongs to the second pattern, and a sample design image, which is an image of the learning sample drawn in accordance with design information of the learning sample. The second learning image, which is captured by illuminating a learning sample by critical illumination, is an image which is in an area where the illumination profile has a second feature. Likewise, the machine learning model 930c is a model that is learned in advance using third learning data, which is a set of a third learning image, which is an image captured by illuminating a learning sample by critical illumination and has an illumination profile that belongs to the third pattern, and a sample design image, which is an image of the learning sample drawn in accordance with design information of the learning sample. The third learning image, which is captured by illuminating a learning sample by critical illumination, is an image which is in an area where the illumination profile has a third feature. Therefore, in this embodiment, the learning data acquisition unit 206 acquires the first learning data, the second learning data, and the third learning data. Then the model learning unit 207 generates the machine learning model 930a that receives the design image as input and outputs the first reference image by performing machine learning by using the first learning data. Likewise, the model learning unit 207 generates the machine learning model 930b which receives the design image as input and outputs the second reference image by performing machine learning using the second learning data, and generates the machine learning model 930c which receives the design image as input and outputs the third reference image by performing machine learning using the third learning data.

In this way, in this embodiment, each of the plurality of machine learning models is a model that has been learned using learning data, which is a set of a learning image, which is an image captured by illuminating a learning sample by critical illumination, and a sample design image, which is an image of the learning sample drawn in accordance with design information of the learning sample. However, in the learning data used for learning, the illumination profile of the critical illumination is different for each of the machine learning models. While three models are selectively used in this embodiment, it is sufficient that the reference image generation unit 204 selectively use at least two models.

The reference image generation unit 204 generates a reference image by using one of the machine learning models thus generated in advance that has been selected according to the illumination profile information. As described above with reference to FIG. 3, the illumination profile information that the reference image generation unit 204 uses in order to generate one reference image is a part of the luminance intensity distribution shown in FIG. 8, like the illumination profile information 931a, 931b, and 931c shown in FIG. 8. Therefore, the reference image generation unit 204 determines which one of the aforementioned three patterns the illumination profile information 931 acquired by the profile acquisition unit 202 in order to generate the reference image belongs to. Then, the reference image generation unit 204 generates the reference image by using one of the machine learning models 930a to 930c that corresponds to the determined pattern. In this embodiment as well, when illumination profile information items are different from each other even when the design image is the same, the reference image generation unit 204 generates reference images different from each other.

The third embodiment has been described above. In this embodiment as well, the reference image is generated taking into consideration the illumination profile at the time of image capturing. Therefore, a more appropriate reference image can be generated. It is sufficient that the illumination profile information according to this embodiment indicate the illumination profile when the inspection image is captured, and may not necessarily be a profile image acquired by the second detector 33.

### [Modified Example]

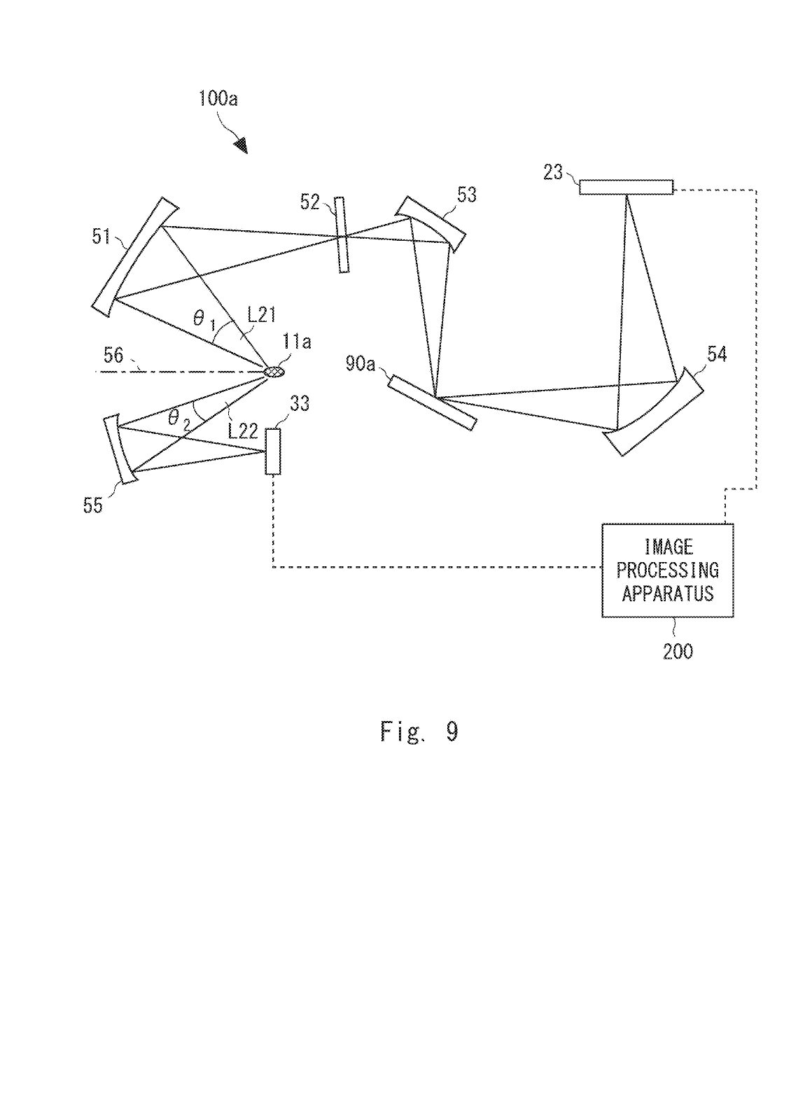

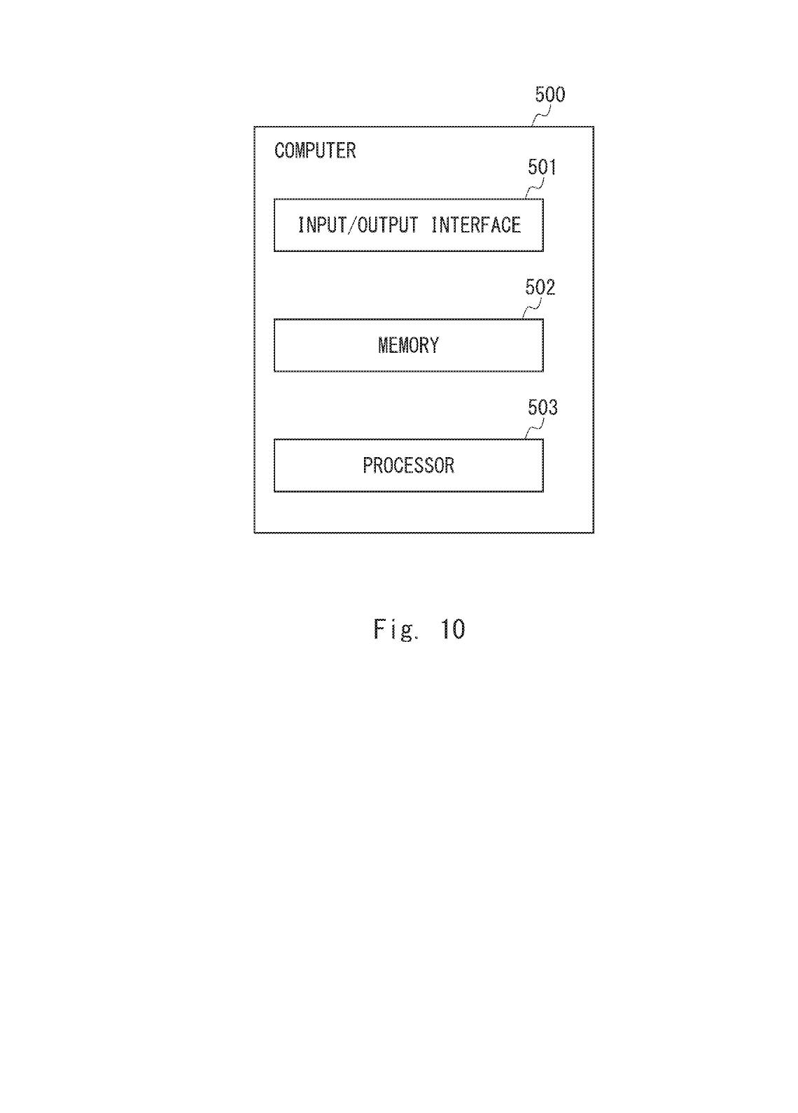

While the configuration example of the imaging apparatus 100 including the first detector 23 and the second detector 33 has been described in the above FIG. 1, the imaging apparatus 100 of the inspection system 1 may be replaced by an imaging apparatus 100a having the following configuration. FIG. 9 is a schematic diagram showing a configuration example of the imaging apparatus 100a according to the modified example. Hereinafter, with reference to FIG. 9, an illumination system of the imaging apparatus 100a will be described.

As shown in FIG. 9, in the imaging apparatus 100a, a first light L21 from a light source 11a reaches a sample 90a via a mirror 51, a homogenizer 52, and a mirror 53, and thus the sample 90a is illuminated. Here, the first light L21 in an angle range θ₁ released from the light source 11a is collected by the mirror 51 for the illumination of the sample 90a. The light from the sample 90a is detected by the first detector 23 via the mirror 54. On the other hand, a second light L22 from the light source 11a is detected by a second detector 33 via a mirror 55. The second light L22 is illumination light having an optical path different from that of the first light L21. Here, the second light L22 in an angle range θ₂ released from the light source 11a is collected by the mirror 55. The aforementioned angle range θ₁ and angle range θ₂ do not overlap each other on the space. The angle range θ₁ and the angle range θ₂ may be symmetric to each other with respect to an axis of symmetry 56 of the light source 11a.

In the configuration shown in FIG. 1, the image obtained by capturing, by the second detector 33, the image obtained by imaging a part of the illumination light that reaches the target to be imaged by the first detector 23 (the upper surface 91 of the sample 90) from the light source 11 is used as the illumination profile information. That is, in the configuration shown in FIG. 1, a part of the illumination light is taken out by the cut mirror 31 and is observed by the second detector 33. On the other hand, with the imaging apparatus 100a according to the modified example shown in FIG. 9, an image obtained by capturing, by the second detector 33, the image obtained by imaging the illumination light of an optical path different from that of the illumination light that reaches the target to be imaged by the first detector 23 is used as the illumination profile information. In this way, when the illumination profile information is acquired by the second detector 33, it is sufficient that this illumination profile information be an image obtained by capturing, by the second detector 33, an image obtained by imaging light from a light source, and whether the light imaged for the second detector 33 is a part of the illumination light that reaches the target to be imaged by the first detector 23 from the light source is not limited.

While the embodiments and the modified example have been described above, the aforementioned function (processing) of the image processing apparatus 200 may be implemented, for example, by a computer 500 having the following configurations.

FIG. 10 is a block diagram showing one example of a configuration of the computer 500 that implements processing in the image processing apparatus 200. As shown in FIG. 10, the computer 500 includes an input/output interface 501, a memory 502, and a processor 503.

The input/output interface 501 is an interface for connecting to another apparatus (e.g., the imaging apparatus 100).

The memory 502 is formed of, for example, a combination of a volatile memory with a non-volatile memory. The memory 502 is used to store software (computer program) including one or more instructions executed by the processor 503, and data or the like used for various kinds of processing. The model storage unit 208 and the design information storage unit 209 may be implemented, for example, by the memory 502, but may be implemented by a desired storage apparatus other than the memory 502.

The processor 503 loads the software (computer program) from the memory 502 and executes the loaded software (computer program), thereby performing the aforementioned processing of the image processing apparatus 200. The processor 503 may be, for example, a microprocessor, a Micro Processor Unit (MPU), a Central Processing Unit (CPU), a Graphics Processing Unit (GPU), or the like. The processor 503 may include a plurality of processors.

The program is included in a computer program product.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Further, the present disclosure is not limited to the aforementioned embodiments and may be changed as appropriate without departing from the spirit of the present disclosure.

Further, the whole or part of the embodiments disclosed above can be described as, but not limited to, the following supplementary notes.

### (Supplementary Note 1)

An image processing method comprising:

a process of acquiring an inspection image, which is an image captured by illuminating, by critical illumination, an inspection target area of an object to be inspected;

a process of acquiring illumination profile information indicating an illumination profile at the time of image capturing;

a process of generating a reference image based on design information of the object to be inspected; and

a process of inspecting the inspection target area by comparing the inspection image with the reference image,

wherein, in the process of generating the reference image, by using the illumination profile information, different reference images are generated for areas that show a common structure in the design information.

### (Supplementary Note 2)

The image processing method according to Supplementary Note 1, wherein, in the process of generating the reference image, the reference image is generated by inputting a design image which is based on the design information and the illumination profile information regarding the inspection image to a machine learning model that is learned in advance.

### (Supplementary Note 3)

The image processing method according to Supplementary Note 2, wherein the machine learning model is a model that is learned using learning data, which is a set of a learning image, which is an image captured by illuminating a learning sample by critical illumination, a sample design image, which is an image of the learning sample drawn in accordance with design information of the learning sample, and illumination profile information indicating an illumination profile when the learning image is captured.

### (Supplementary Note 4)

The image processing method according to Supplementary Note 1, wherein

in the process of generating the reference image,

a design image which is based on the design information is corrected, by an optical simulation that uses the illumination profile information regarding the inspection image, to a design image on which the illumination profile information is reflected, and

the reference image is generated by inputting the corrected design image to a machine learning model learned in advance.

### (Supplementary Note 5)

The image processing method according to Supplementary Note 4, wherein the machine learning model is a model learned by using learning data, which is a set of a learning image, which is an image captured by illuminating a learning sample by critical illumination, and a sample design image, which is an image of the learning sample drawn in accordance with design information of the learning sample.

### (Supplementary Note 6)

The image processing method according to Supplementary Note 1, wherein, in the process of generating the reference image, the reference image is generated by inputting a design image which is based on the design information to one of a plurality of machine learning models learned in advance that has been selected based on the illumination profile information regarding the inspection image.

### (Supplementary Note 7)

The image processing method according to Supplementary Note 6, wherein

each of the plurality of machine learning models is a model that is learned using learning data, which is a set of a learning image, which is an image captured by illuminating a learning sample by critical illumination, and a sample design image which is based on design information of the learning sample, and

in the learning data used for the learning, a characteristic of an illumination profile of the critical illumination is different for each of the machine learning models.

### (Supplementary Note 8)

The image processing method according to any one of Supplementary Notes 1 to 7, wherein

in the process of acquiring the inspection image, the inspection image captured by using a first detector is acquired,

the first detector is a TDI sensor that has image pickup elements arranged in a first direction and a second direction and accumulates electrical charges from the plurality of respective image pickup elements arranged in the second direction, and

the illumination profile information indicates a luminance intensity distribution of illumination light in the first direction.

### (Supplementary Note 9)

The image processing method according to any one of Supplementary Notes 1 to 8, wherein

in the process of acquiring the inspection image, the inspection image captured by using a first detector is acquired, and

the illumination profile information is an image obtained by capturing, by a second detector, an image obtained by imaging light from a light source.

### (Supplementary Note 10)

The image processing method according to Supplementary Note 9, wherein the illumination profile information is an image obtained by capturing, by the second detector, an image obtained by imaging a part of illumination light that reaches a target to be imaged by the first detector from the light source.

### (Supplementary Note 11)

An image processing apparatus comprising:

an image acquisition unit configured to acquire an inspection image, which is an image captured by illuminating, by critical illumination, an inspection target area of an object to be inspected;

a profile acquisition unit configured to acquire illumination profile information indicating an illumination profile at the time of image capturing;

a reference image generation unit configured to generate a reference image based on design information of the object to be inspected; and

an inspection unit configured to inspect the inspection target area by comparing the inspection image with the reference image,

wherein the reference image generation unit generates different reference images for areas that show a common structure in the design information by using the illumination profile information.

### (Supplementary Note 12)

The image processing apparatus according to Supplementary Note 11, wherein the reference image generation unit generates the reference image by inputting a design image which is based on the design information and the illumination profile information regarding the inspection image to a machine learning model that is learned in advance.

### (Supplementary Note 13)

The image processing apparatus according to Supplementary Note 12, wherein the machine learning model is a model that is learned using learning data, which is a set of a learning image, which is an image captured by illuminating a learning sample by critical illumination, a sample design image, which is an image of the learning sample drawn in accordance with design information of the learning sample, and illumination profile information indicating an illumination profile when the learning image is captured.

### (Supplementary Note 14)

The image processing apparatus according to Supplementary Note 11, wherein

the reference image generation unit corrects, by an optical simulation that uses the illumination profile information regarding the inspection image, a design image which is based on the design information to a design image on which the illumination profile information is reflected, and

the reference image is generated by inputting the corrected design image to a machine learning model learned in advance.

### (Supplementary Note 15)

The image processing apparatus according to Supplementary Note 14, wherein the machine learning model is a model that is learned using learning data, which is a set of a learning image, which is an image captured by illuminating a learning sample by critical illumination, and a sample design image, which is an image of the learning sample drawn in accordance with design information of the learning sample.

### (Supplementary Note 16)

The image processing apparatus according to Supplementary Note 11, wherein, the reference image generation unit generates the reference image by inputting a design image which is based on the design information to one of a plurality of machine learning models learned in advance that has been selected based on the illumination profile information regarding the inspection image.

### (Supplementary Note 17)

The image processing apparatus according to Supplementary Note 16, wherein

each of the plurality of machine learning models is a model that is learned using learning data, which is a set of a learning image, which is an image captured by illuminating a learning sample by critical illumination, and a sample design image which is based on design information of the learning sample, and

in the learning data used for the learning, a characteristic of an illumination profile of the critical illumination is different for each of the machine learning models.

### (Supplementary Note 18)

The image processing apparatus according to any one of Supplementary Notes 11 to 17, wherein

the image acquisition unit acquires the inspection image captured by using a first detector,

the first detector is a TDI sensor that has image pickup elements arranged in a first direction and a second direction and accumulates electrical charges from the plurality of respective image pickup elements arranged in the second direction, and

the illumination profile information indicates a luminance intensity distribution of illumination light in the first direction.

### (Supplementary Note 19)

The image processing apparatus according to any one of Supplementary Notes 11 to 18, wherein

the image acquisition unit acquires the inspection image captured by using a first detector, and

the illumination profile information is an image obtained by capturing, by a second detector, an image obtained by imaging light from a light source.

### (Supplementary Note 20)

The image processing apparatus according to Supplementary Note 19, wherein the illumination profile information is an image obtained by capturing, by the second detector, an image obtained by imaging a part of illumination light that reaches a target to be imaged by the first detector from the light source.

### (Supplementary Note 21)

A learning method comprising:

a process of acquiring learning data, which is a set of a learning image, which is an image captured by illuminating a learning sample by critical illumination, a sample design image which is based on design information of the learning sample, and illumination profile information indicating an illumination profile when the learning image is captured; and

a process of generating, by performing machine learning by using the learning data, a machine learning model which receives a target design image and illumination profile information indicating an illumination profile when an inspection image is captured as input and outputs a reference image, wherein

the target design image is an image of an inspection target area of an object to be inspected drawn in accordance with design information of the object to be inspected,

the inspection image is an image captured by illuminating, by critical illumination, the inspection target area of the object to be inspected, and

the reference image is an image that is compared with the inspection image to inspect the inspection target area.

### (Supplementary Note 22)

A learning method comprising:

a process of acquiring at least:

first learning data, which is a set of a first learning image, which is an image captured by illuminating a learning sample by critical illumination and which is in an area where an illumination profile has a first feature, and a sample design image which is based on design information of the learning sample;

second learning data, which is a set of a second learning image, which is an image captured by illuminating the learning sample by critical illumination and which is in an area where an illumination profile has a second feature, and the sample design image;

a process of generating a first machine learning model that receives a target design image as input and outputs a first reference image by performing machine learning by using the first learning data and generating a second machine learning model that receives the target design image as input and outputs a second reference image by performing machine learning by using the second learning data, wherein

the target design image is an image of an inspection target area of an object to be inspected drawn in accordance with design information of the object to be inspected,

the first reference image and the second reference image are images to be compared with an inspection image to inspect the inspection target area, and

the inspection image is an image captured by illuminating, by critical illumination, the inspection target area of the object to be inspected.

### (Supplementary Note 23)

A program for causing a computer to execute:

a step of acquiring an inspection image, which is an image captured by illuminating, by critical illumination, an inspection target area of an object to be inspected;

a step of acquiring illumination profile information indicating an illumination profile at the time of image capturing;

a step of generating a reference image based on design information of the object to be inspected; and

a step of inspecting the inspection target area by comparing the inspection image with the reference image,

wherein, in the step of generating the reference image, different reference images are generated for areas that show a common structure in the design information by using the illumination profile information.

### (Supplementary Note 24)

The program according to Supplementary Note 23, wherein, in the step of generating the reference image, the reference image is generated by inputting a design image which is based on the design information and the illumination profile information regarding the inspection image to a machine learning model that is learned in advance.

### (Supplementary Note 25)

The program according to Supplementary Note 24, wherein the machine learning model is a model that is learned using learning data, which is a set of a learning image, which is an image captured by illuminating a learning sample by critical illumination, a sample design image, which is an image of the learning sample drawn in accordance with design information of the learning sample, and illumination profile information indicating an illumination profile when the learning image is captured.

### (Supplementary Note 26)

The program according to Supplementary Note 23, wherein

in the step of generating the reference image,

a design image which is based on the design information is corrected, by an optical simulation that uses the illumination profile information regarding the inspection image, to a design image on which the illumination profile information is reflected, and

the reference image is generated by inputting the corrected design image to a machine learning model learned in advance.

### (Supplementary Note 27)

The program according to Supplementary Note 26, wherein the machine learning model is a model that is learned using learning data, which is a set of a learning image, which is an image captured by illuminating a learning sample by critical illumination, and a sample design image, which is an image of the learning sample drawn in accordance with design information of the learning sample.

### (Supplementary Note 28)

The program according to Supplementary Note 23, wherein, in the step of generating the reference image, the reference image is generated by inputting a design image which is based on the design information to one of a plurality of machine learning models learned in advance that has been selected based on the illumination profile information regarding the inspection image.

### (Supplementary Note 29)

The program according to Supplementary Note 28, wherein

each of the plurality of machine learning models is a model that is learned using learning data, which is a set of a learning image, which is an image captured by illuminating a learning sample by critical illumination, and a sample design image which is based on design information of the learning sample, and

in the learning data used for the learning, a characteristic of an illumination profile of the critical illumination is different for each of the machine learning models.

### (Supplementary Note 30)

The program according to any one of Supplementary Notes 23 to 29, wherein

in the step of acquiring the inspection image, the inspection image captured by using a first detector is acquired,

the first detector is a TDI sensor that has image pickup elements arranged in a first direction and a second direction and accumulates electrical charges from the plurality of respective image pickup elements arranged in the second direction, and

the illumination profile information indicates a luminance intensity distribution of illumination light in the first direction.

### (Supplementary Note 31)

The program according to any one of Supplementary Notes 23 to 30, wherein

in the step of acquiring the inspection image, the inspection image captured by using a first detector is acquired, and

the illumination profile information is an image obtained by capturing, by a second detector, an image obtained by imaging light from a light source.

### (Supplementary Note 32)

The program according to Supplementary Note 31, wherein the illumination profile information is an image obtained by capturing, by the second detector, an image obtained by imaging a part of illumination light that reaches a target to be imaged by the first detector from the light source.

### (Supplementary Note 33)

An image processing method comprising:

a process of acquiring an inspection image, which is an image captured by illuminating, by critical illumination, an inspection target area of an object to be inspected;

a process of acquiring illumination profile information indicating an illumination profile at the time of image capturing;

a process of generating a reference image from a design image, which is an image of the inspection target area drawn in accordance with design information of the object to be inspected; and

a process of inspecting the inspection target area by comparing the inspection image with the reference image,

wherein, in the process of generating the reference image, by using the illumination profile information, different reference images are generated for a first inspection image and a second inspection image, which are inspection images whose illumination profiles at the time of image capturing are different from each other.

The first to third embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An image processing method comprising:
a process of acquiring an inspection image, which is an image captured by illuminating, by critical illumination, an inspection target area of an object to be inspected;
a process of acquiring illumination profile information indicating an illumination profile at the time of image capturing;
a process of generating a reference image based on design information of the object to be inspected; and
a process of inspecting the inspection target area by comparing the inspection image with the reference image,
wherein, in the process of generating the reference image, by using the illumination profile information, different reference images are generated for areas that show a common structure in the design information.

2. The image processing method according to claim 1, wherein, in the process of generating the reference image, the reference image is generated by inputting a design image which is based on the design information and the illumination profile information regarding the inspection image to a machine learning model that is learned in advance.

3. The image processing method according to claim 2, wherein the machine learning model is a model that is learned using learning data, which is a set of a learning image, which is an image captured by illuminating a learning sample by critical illumination, a sample design image, which is an image of the learning sample drawn in accordance with design information of the learning sample, and illumination profile information indicating an illumination profile when the learning image is captured.

4. The image processing method according to claim 1, wherein
in the process of generating the reference image,
a design image which is based on the design information is corrected, by an optical simulation that uses the illumination profile information regarding the inspection image, to a design image on which the illumination profile information is reflected, and
the reference image is generated by inputting the corrected design image to a machine learning model learned in advance.

5. The image processing method according to claim 4, wherein the machine learning model is a model learned by using learning data, which is a set of a learning image, which is an image captured by illuminating a learning sample by critical illumination, and a sample design image, which is an image of the learning sample drawn in accordance with design information of the learning sample.

6. The image processing method according to claim 1, wherein, in the process of generating the reference image, the reference image is generated by inputting a design image which is based on the design information to one of a plurality of machine learning models learned in advance that has been selected based on the illumination profile information regarding the inspection image.

7. The image processing method according to claim 6, wherein
each of the plurality of machine learning models is a model that is learned using learning data, which is a set of a learning image, which is an image captured by illuminating a learning sample by critical illumination, and a sample design image which is based on design information of the learning sample, and
in the learning data used for the learning, a characteristic of an illumination profile of the critical illumination is different for each of the machine learning models.

8. The image processing method according to claim 1, wherein
in the process of acquiring the inspection image, the inspection image captured by using a first detector is acquired,
the first detector is a TDI sensor that has image pickup elements arranged in a first direction and a second direction and accumulates electrical charges from the plurality of respective image pickup elements arranged in the second direction, and
the illumination profile information indicates a luminance intensity distribution of illumination light in the first direction.

9. The image processing method according to claim 1, wherein
in the process of acquiring the inspection image, the inspection image captured by using a first detector is acquired, and
the illumination profile information is an image obtained by capturing, by a second detector, an image obtained by imaging light from a light source.

10. An image processing apparatus comprising:
at least one memory storing instructions; and
at least one processor configured to execute the instructions to:
acquire an inspection image, which is an image captured by illuminating, by critical illumination, an inspection target area of an object to be inspected;
acquire illumination profile information indicating an illumination profile at the time of image capturing;
generate a reference image based on design information of the object to be inspected; and
inspect the inspection target area by comparing the inspection image with the reference image,
wherein, in generating the reference image, different reference images are generated for areas that show a common structure in the design information by using the illumination profile information.

11. The image processing apparatus according to claim 10, wherein the processor is configured to execute the instructions to generate the reference image by inputting a design image which is based on the design information and the illumination profile information regarding the inspection image to a machine learning model that is learned in advance.

12. The image processing apparatus according to claim 11, wherein the machine learning model is a model that is learned using learning data, which is a set of a learning image, which is an image captured by illuminating a learning sample by critical illumination, a sample design image, which is an image of the learning sample drawn in accordance with design information of the learning sample, and illumination profile information indicating an illumination profile when the learning image is captured.

13. The image processing apparatus according to claim 10, wherein the processor is configured to execute the instructions to:
correct, by an optical simulation that uses the illumination profile information regarding the inspection image, a design image which is based on the design information to a design image on which the illumination profile information is reflected; and
generate the reference image by inputting the corrected design image to a machine learning model learned in advance.

14. The image processing apparatus according to claim 13, wherein the machine learning model is a model that is learned using learning data, which is a set of a learning image, which is an image captured by illuminating a learning sample by critical illumination, and a sample design image, which is an image of the learning sample drawn in accordance with design information of the learning sample.

15. The image processing apparatus according to claim 10, wherein, the processor is configured to execute the instructions to generate the reference image by inputting a design image which is based on the design information to one of a plurality of machine learning models learned in advance that has been selected based on the illumination profile information regarding the inspection image.

16. The image processing apparatus according to claim 15, wherein
each of the plurality of machine learning models is a model that is learned using learning data, which is a set of a learning image, which is an image captured by illuminating a learning sample by critical illumination, and a sample design image which is based on design information of the learning sample, and
in the learning data used for the learning, a characteristic of an illumination profile of the critical illumination is different for each of the machine learning models.

17. The image processing apparatus according to claim 10, wherein
the processor is configured to execute the instructions to acquire the inspection image captured by using a first detector,
the first detector is a TDI sensor that has image pickup elements arranged in a first direction and a second direction and accumulates electrical charges from the plurality of respective image pickup elements arranged in the second direction, and
the illumination profile information indicates a luminance intensity distribution of illumination light in the first direction.

18. The image processing apparatus according to claim 10, wherein
the processor is configured to execute the instructions to acquire the inspection image captured by using a first detector, and
the illumination profile information is an image obtained by capturing, by a second detector, an image obtained by imaging light from a light source.

19. A learning method comprising:
a process of acquiring learning data, which is a set of a learning image, which is an image captured by illuminating a learning sample by critical illumination, a sample design image which is based on design information of the learning sample, and illumination profile information indicating an illumination profile when the learning image is captured; and
a process of generating, by performing machine learning by using the learning data, a machine learning model which receives a target design image and illumination profile information indicating an illumination profile when an inspection image is captured as input and outputs a reference image, wherein
the target design image is an image of an inspection target area of an object to be inspected drawn in accordance with design information of the object to be inspected,
the inspection image is an image captured by illuminating, by critical illumination, the inspection target area of the object to be inspected, and
the reference image is an image that is compared with the inspection image to inspect the inspection target area.
